(19) United States
(12) Patent Application Publication
(10) Pub. No.: US 2026/0119135 A1
(43) Pub. Date: Apr. 30, 2026

(54) GENERATING A CONTROL PROGRAM FOR A TARGET PLATFORM AND CONFIGURING A TARGET PLATFORM CONFIGURED AS A CONTROLLER

(71) Applicant: dSPACE GmbH, Paderborn (DE)

(72) Inventors: Michael Mair, Paderborn (DE); Sebastian Hillebrand, Paderborn (DE); Renate Hein, Paderborn (DE)

(21) Appl. No.: 19/322,742

(22) Filed: Sep. 9, 2025

(30) Foreign Application Priority Data
Oct. 29, 2024 (DE) 102024131471.0

(51) Int. Cl. G06F 8/35; G06F 8/34; G06F 8/41

(52) U.S. Cl. CPC G06F 8/35; G06F 8/34; G06F 8/443

(57) ABSTRACT

A computer-implemented method is provided for generating a control program for a target platform from a graphical control model of a development platform. The graphical control model includes a block diagram having a plurality of blocks. The graphical control model references a definition database in which information relating to the graphical control model is stored. The definition database includes at least one target specification object. The method includes: generating the control program according to target platform-specific generation rules for the control program comprised in the target specification object, wherein the target specification object is referenced by one or more blocks of the graphical control model, and wherein the target platform-specific generation rules for control program portions that correspond to the blocks referencing the target specification object are taken into account when generating the control program.

### CROSS-REFERENCE TO PRIOR APPLICATIONS

This application claims benefit to German Patent Application No. DE 102024131471.0, filed on Oct. 29, 2024, which is hereby incorporated by reference herein.

### FIELD

The invention relates to a computer-implemented method for generating a control program for a target platform from a graphical control model of a development platform.

In addition, the invention relates to a method for configuring a target platform configured as a controller, in which a control program for the target platform is created from an input graphical control model in accordance with the above method.

In addition, the invention relates to a data processing device capable of carrying out the above method.

The invention further relates to a computer program product comprising commands which, when the program is executed by a computer, cause said computer to carry out the above method.

The invention further relates to a computer-readable data medium on which the above computer program product is stored.

### BACKGROUND

Methods for creating a control program from a graphical control model in a computer-assisted manner have been known for some time and are some of the fundamental functionalities of development environments. In particular, programs for control systems, for example controllers, can thus be built.

The graphical control model is often in the form of a block diagram with the aid of which the mathematical functionality of a control algorithm is modeled and displayed, for example. Via the graphical control model, processes, control devices, and/or generally the response of the controller can first be simulated, and it can be checked whether desired properties are present. The block diagram forming the model generally comprises a plurality of blocks that are connected by signal lines and execute operations such as calculations, it being possible, for example, for a block to calculate an output signal from a plurality of input signals. Signals of different signal types can be transmitted between the blocks via the signal lines, or even via memory areas that are globally accessible for the graphical control model.

Generally, block diagrams are executed cyclically, with all the blocks being retained permanently in the memory and each block being executed once per time step. In particular, a block can apply one or more operations to input signals from the last time step in order to create output signals of the current time step. Accordingly, the usual assumptions in relation to control programs, for example a lifetime of variables of the control program, cannot be readily carried over to the graphical control model.

Besides a cyclically executed sub-model for describing the almost continuous-time response of the controller, graphical control models can also comprise a sub-model for describing a discrete response in which a number of states and transitional conditions are defined.

Methods for creating control programs from graphical control models are also referred to as code generators. These are computer programs that translate the graphical control model into source code of the selected target platform, i.e., into the control program. Unlike the graphical control model, the control program is entirely in text form and comprises instructions for execution on the target platform. Code generators thus ensure reliable, error-free implementation of an abstract functional description (graphical control model) in a program for the target platform (control system).

Code generation usually involves creating a variable in the source code for each output of a block. However, the disadvantage of this is that generally more variables than are actually needed are initially produced. The number of variables, or generally the size of the code, can be reduced by subsequent optimization. In this regard, EP 2 418 577 A1 discloses transforming a block diagram into an intermediate representation and applying at least one optimization to this intermediate representation in order to create an optimized intermediate representation. A multiplicity of further optimizations, which are known per se from compiler construction, can be applied successively to create further-optimized intermediate representations. Next, the control program is created from the optimized intermediate representation, preferably in C code. A method for creating a control program is described, for example, in document DE 10 2020 124 080 A1 or document EP 2 916 183 B1.

Complex control programs or constituents thereof, for example source code which uses artificial neural networks, generally make use of program libraries in order to perform calculations. Unlike the control program, program libraries do not have any units that can run autonomously; rather, they contain auxiliary modules and/or constituents that are requested by the control program. Program libraries can be used by the control program at different times, for example before the runtime of the control program during compiling, during the runtime of the control program, and/or during just-in-time compiling, in order to translate the control program or constituents thereof during the runtime into code that is executable for an arithmetic logic unit of the target platform. Furthermore, in complex control programs, it is necessary to use what are known as bare-metal programming solutions, in which the programming runs on the hardware layer of the target platform such that the control program or parts thereof can function without the abstraction layer of an operating system.

Accordingly, complex control programs are highly dependent on the software- and hardware-based characteristics of the target platform, meaning that changing the target platform for complex control programs created from a graphical control model is very laborious, thus making it more difficult to develop and test control programs. In particular, implementing the calculation by integrating libraries and/or implementing the calculation by way of bare-metal programming solutions generally goes beyond the source code created by the code generators.

To ensure the controller has good performance overall, it is also desirable to be able to take account of specific hardware configurations of the target platform. For example, special vector processes provide the possibility of executing calculations on similar data at the same time in a vector. However, architectures having special machine instructions for vectors need support to use said vectors from higher programming languages like the control program, for example through language extensions for generating array functions. For this reason, these functionalities can generally only be used if, when the control program is being built, the architecture of the target platform is also known and explicit modeling takes place. During explicit modeling, however, the key advantages of model-based development using the graphical control model are lost.

### SUMMARY

In an exemplary embodiment, the present invention provides a computer-implemented method for generating a control program for a target platform from a graphical control model of a development platform. The graphical control model comprises a block diagram having a plurality of blocks. The graphical control model references a definition database in which information relating to the graphical control model is stored. The definition database comprises at least one target specification object. The method comprises: generating the control program according to target platform-specific generation rules for the control program comprised in the target specification object, wherein the target specification object is referenced by one or more blocks of the graphical control model, and wherein the target platform-specific generation rules for control program portions that correspond to the blocks referencing the target specification object are taken into account when generating the control program.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a data processing device according to a preferred embodiment example of the invention;

FIG. 2 schematically shows the software components installed on the device according to FIG. 1;

FIG. 3 schematically shows, in the top part, a graphical control model on the basis of which a computer-implemented method for generating a control program according to a preferred embodiment example of the invention is explained, the bottom part of FIG. 3 illustrating the generated control program;

FIG. 4 schematically shows a piece of heterogeneous hardware of a target platform for which a control program is created by the method from FIG. 3;

FIG. 5 schematically shows, in a), a software architecture for an implementation example of the hardware from FIG. 4, in b), a schematic illustration of a target specification object, and in c), a schematic program sequence of the control program generated via the method illustrated in FIG. 3 on the architecture shown in FIG. 5; and

FIG. 6 schematically shows, in a), a software architecture for a further embodiment example of the hardware from FIG. 4, in b), a schematic illustration of a further target specification object, and in c), a schematic program sequence of the control program generated via the method illustrated in FIG. 3 on the architecture shown in FIG. 6.

### DETAILED DESCRIPTION

Exemplary embodiments of the invention provide for improving the ability to adapt the creation of a control program from a graphical control model to different target platforms and/or to characteristics of the target platform.

In an exemplary embodiment, a computer-implemented method is provided for generating a control program for a target platform from a graphical control model of a development platform, the graphical control model comprising a block diagram having a plurality of blocks, the graphical control model referencing a definition database in which information relating to the graphical control model is stored, and the definition database comprising at least one target specification object. In this case, it is provided in particular that the target specification object comprises target platform-specific generation rules for the control program, the target specification object is referenced by one or more blocks of the graphical control model, and the target platform-specific generation rules for control program portions that correspond to the blocks referencing the target specification object are taken into account when creating the control program.

The method according to an exemplary embodiment of the invention thus makes use of the target specification object in the definition database in order, when creating the control program, to take account of the target platform-specific generation rules for those portions of the control program that correspond to the blocks referencing the target specification object in the graphical control model.

This therefore allows the specification of target platform-specific implementation variants of the control program to be taken into account. In particular, target platform-specific characteristics and dependencies can thus also be taken into account during the build process for the control program. Preferably, the build process should be construed to mean the operation in which code that is executable for an arithmetic logic unit of the target platform is created in an automated manner and, in particular, the executable code is compiled and/or linked to program libraries. Since account is taken of target platform-specific generation rules for those portions of the control program that correspond to the blocks referencing the target specification object in the graphical control model, account is also taken of the fact that particular dependencies are only associated with particular blocks.

Furthermore, the present method makes it possible to correctly generate the control program for a specific target platform starting from the graphical control model without any workarounds via the graphical control model. Preferably, to create the control program, it is not necessary to first outsource model portions of blocks, in which target platform-specific characteristics are to be taken into account, to a subsystem of the graphical control model and convert them according to the specific requirements of the target platform and integrate them back into the graphical control model in a different subsystem of the graphical control model as external code. Instead, the desired configuration of the control program can be programmed via the target specification object for the corresponding blocks of the graphical control model. Further preferably, the present method makes it possible to create, starting from the graphical control model, a control program that takes account of target platform-specific dependencies without the created control program for the corresponding target platform directly containing specific call-ups of program libraries for this purpose. Instead, in the created control program, reference is made to the target specification object, which comprises the target platform-specific generation rules.

The block diagram of the graphical control model comprises a plurality of blocks. Preferably, the block diagram is configured to transmit signals between at least two blocks. For this purpose, it can be provided that a first block issues an output signal, which may consist of one value or a plurality of associated values depending on the definition, and a second block receives this signal as its input signal and takes the signal into account when determining its output signal. The signal can be transmitted via either signal lines that interconnect the blocks or memory areas that are globally accessible for the control model, meaning that signals can even be transmitted between blocks that are not directly connected via signal lines.

The blocks in the block diagram can be atomic, i.e., from the perspective of the surrounding blocks can form a unit in which all the input signals have to be applied at the start of a computing step and all the output signals are present at the end of a computing step. If block diagrams are hierarchical, a multiplicity of blocks in a subordinate layer can describe the structure of one block in a superordinate layer. Hierarchical or composite blocks, even if they are atomic, can comprise a multiplicity of blocks in a subordinate layer.

The graphical control model references the definition database in which information relating to the graphical control model is stored. In particular, the definition database comprises the target specification object for specifying the target platform-specific generation rules for the control program. In particular, the definition database is configured such as to allow target platform-specific dependencies and/or target platform-specific instructions for different target platforms to be combined. Since, in addition, one or more blocks of the graphical control model reference the target specification object, it is also ensured that the definition database is configured such as to allow target platform-specific dependencies and/or target platform-specific instructions to be located in individual blocks. By way of example, the definition database can have a tree structure. Further preferably, it is provided that the target specification object also comprises standard generation rules for the control program that are taken into account as defaults when the control program is created, in particular for situations where no target platform is specified by the user.

When determining the control program from the graphical control model, the control program is preferably generated in a multi-stage process. In this process, use is preferably made of the information stored in the definition database, and particularly preferably of the target specification object. The control program (also referred to as source code) is preferably entirely in text form and preferably comprises instructions for the target platform, which is preferably configured as a controller.

According to a preferred development of the invention, it is provided that the target platform-specific generation rules for the control program take account of characteristics of a control program language, a piece of hardware of the target platform, a hardware setting of the target platform, a runtime environment of the target platform, a compiler for creating from the control program a code which is executable for an arithmetic logic unit of the target platform, a compiler version, and/or a compiler setting.

Via the target specification object, different characteristics relating to the target platform, such as the control program language, hardware, hardware settings, runtime environment, compiler, compiler version, and/or compiler setting, can preferably be taken into account, and in this way control program implementation variants taking account of these characteristics can be specified. In other words, therefore, different control program implementation variants for different target platforms can preferably be specified in the target specification object.

The runtime environment of the target platform preferably comprises all the stipulated requirements of the runtime system of the target platform that are available during the runtime of the control program. The runtime system is preferably defined by the basic constituents of the control program language, for example the behavior of language constructs and further functions such as type testing, debugging, and/or the creation, and preferably the optimization, of code that is executable for the target platform. The runtime environment preferably also comprises the program libraries requested by the control program, such as the runtime library and/or standard libraries, programming interfaces, runtime variables, and/or accesses to hardware components and/or software components of the target platform.

Usually, a compiler offers options for different optimizations aimed at improving the runtime of the code that is executable for the arithmetic logic unit of the target platform or minimizing the memory space requirements thereof. By way of example, the optimizations can be carried out on the basis of the properties of the hardware of the target platform, for example how many registers of the processor of the controller are available and which ones. Preferably, it is also provided that control program implementation variants can be specified in the target specification object in order to take account of characteristics of the compiler, of the compiler version, and/or of the compiler setting.

Preferably, for example, the management of the dependencies resulting from integrations of program libraries can be simplified via the target specification object. For instance, a corresponding control program implementation variant can be specified in the target specification object in order to create source objects and/or integrations of program libraries. Furthermore, search paths or build settings, such as compiler or linker switches, can be specified in the target specification object. Further preferably, via the target specification object, it is also possible to specify build dependencies for downstream hardware such as co-processors and/or FPGAs (field-programmable gate arrays), as well as build descriptions for creating wrapper code. Moreover, the target specification object preferably provides the possibility of specifying, via the target specification object, control program implementation variants for activating services for service-based architectures of the target platform and/or for the abstractions for APIs (application programming interfaces). An API is a program part made available by a software system to other programs in order to interface with the system. An API can, for example, enable or simplify access to hardware of the target platform, for example the memory or processor. Further preferably, it is possible to specify, via the target specification object, build descriptions for creating wrapper code in order to embed the services in corresponding service-based architectures and/or build descriptions for providing such services.

In other words, the target specification object thus preferably allows build dependencies and build instructions for different target platforms to be combined and located in individual blocks of the graphical control model.

According to another preferred development of the invention, it is provided that that block of the graphical control model which references the target specification object performs signal processing, the result of which is used by at least one other block in the graphical control model, and that, when the control program is created, the control program is generated in such a way that a function prototype corresponding to the transmission of the result is independent of the target platform-specific configuration of that portion of the control program which corresponds to the block referencing the target specification object.

Preferably, the function prototype denotes the declaration of a function of the control program, further preferably including information on the number and type of the parameters of the function and data type of the return value. Thus, the function prototype specifies the interface of the function to other functions of the control program. In other words, it is thus preferably provided that the interface of the function that has a target platform-specific configuration is independent of that target platform-specific configuration. Put another way, despite the target platform-specific configuration of the function, the interface of the function is preferably the same for all possible target platform-specific configurations. Therefore, since the function interface to the environment is preferably stable, any exchanging of the implementation is also locally restricted. Accordingly, it is possible to simply run through a plurality of target platform-specific control program implementation variants, for example in the context of a profile-guided optimization, in order to find the best-possible configuration, for example when resources are limited. By way of example, during the profile-guided optimization it can be determined that the execution of certain constituents of the control program should be outsourced to a co-processor in order to take account of characteristics of the hardware of the target platform. An advantage is thus that it is possible to vary the target platform-specific implementation while retaining the same modeling in the graphical control model and the same interface at the level of the created control program.

In this context, it is provided according to a further development of the invention that that block of the graphical control model which references the target specification object relays a signal to at least one other block, and that, when the control program is created, the control program is generated in such a way that information about a return value of the function in the function prototype is independent of the target platform-specific configuration of that portion of the control program which corresponds to the block referencing the target specification object. Since the return value of the function is the same despite the target platform-specific configuration of the function, when changing the target platform there is no need to adapt further functions of the control program that continue to use the return value of the function.

Furthermore, in this context, it is provided according to a further development of the invention that that block of the graphical control model which references the target specification object receives at least one signal, and that, when the control program is created, the control program is generated in such a way that information about function parameters in the function prototype is independent of the target platform-specific configuration of that portion of the control program which corresponds to the block referencing the target specification object. Since the information about the function parameters, and preferably the information about the number and data type of the function parameters, is the same despite the target platform-specific configuration of the function, when changing the target platform there is no need to adapt further functions that call up the function tailored to the characteristics of the target platform.

According to another preferred development of the invention, it is provided that the block diagram has a hierarchical structure and comprises at least one first subsystem and one second subsystem, the first subsystem being an external subsystem such that the second subsystem is comprised by the first subsystem, the second subsystem comprising at least one block which references the target specification object, and, when the control program for the target platform is created, the control program is generated in such a way that the referencing is hierarchically transmitted from that portion of the control program corresponding to the second subsystem to that portion of the control program corresponding to the first subsystem.

When the graphical control model has a hierarchical structure, a multiplicity of blocks in a subordinate layer—the second subsystem in the present case—can describe the structure of one block in a superordinate layer—the first subsystem in the present case. Subsystems can have additional properties such as implementation in a separate function and/or triggering of the execution of the subsystem via a dedicated signal. In subsystems, special blocks can be arranged in order to further specify the properties of the subsystem. In particular, it is provided that if a block of an internal subsystem references the target specification object, then when the control program is created, the referencing to the target specification object is hierarchically transmitted from that portion of the control program corresponding to the internal subsystem to that portion of the control program corresponding to the external subsystem.

In a further preferred development of the invention, it is preferably provided that, when the control program is generated, the target specification object is included as a link for that portion of the control program which corresponds to the block referencing the target specification object. This allows the target platform-specific information to be retained and transmitted in a simple manner.

According to another preferred development of the invention, it is preferably provided that that block of the graphical control model which references the target specification object is configured as a function block having an external function. The function block having the external function can be a user-specific code block (also referred to as a custom code block) specified by the user. Referencing the target specification object in which the target platform-specific generation rules for the control program are specified can thus also ensure that external functionalities having different build dependencies are integrated. In particular, owing to the stable function interface, it is possible to use the same wrapper call-ups for all the different target platforms in the control program, and the specific implementation of the wrappers is preferably down to the user. When creating the control program, the link of the function block to the target specification object is preferably included such that the information for the build process is provided at that point of the external function in the generated control program via the link.

According to a preferred development of the invention, creating the control program for the target platform from the graphical control model of the development platform comprises the steps of:
creating an intermediate representation from the graphical control model,
optimizing the created intermediate representation, and
creating the control program for the target platform by translating the optimized intermediate representation,
   at least one of the steps comprising taking account of the target platform-specific generation rules for control program portions which correspond to the blocks referencing the target specification object.

Therefore, a method is preferably provided for creating the control program for the target platform from the graphical control model of the development platform, in which creating the control program comprises transforming the graphical control model into an intermediate representation, preferably successively optimizing the intermediate representation, and translating the optimized intermediate representation into the control program, at least one of the steps being performed while taking account of the target platform-specific generation rules stored in the target specification object. In this way, all the information from the graphical control model is still available.

Preferably, in the intermediate representation the blocks of the block diagram of the graphical control model are translated into instructions having a fixed order of execution, as a result of which the structure of the intermediate representation semantically maps a text-based programming language. The transforming step can include a plurality of sub-steps such as checking a number of rules and attaching further code generation information. The target platform-specific generation rules for control program portions that correspond to the blocks referencing the target specification object can in principle be taken into account in any intermediate step of the transformation and are preferably taken into account in every transformation step.

According to another preferred development of the invention, it is provided that the control program is created such that control program portions which correspond to the blocks referencing the target specification object comprise information for creating the executable code. In particular, therefore, the information relevant for the build process is included, particularly preferably information regarding the runtime environment of the target platform and the dependencies resulting from the integration of program libraries, as well as information regarding the compiler, the compiler version, and/or the compiler settings.

According to a further development of the invention, it is provided that the control program is created at least partly in C code. Apart from the portion in C code, the control program preferably comprises textual information not necessarily in C code. Particularly preferably, this is the information for creating the executable code. Further preferably, this information is available in a makefile and/or can be used to create a makefile. Preferably, the dependencies of the build process are recorded in a formalized manner in a makefile.

In the present case, C code means a programming language that is built on C in terms of syntax and/or underlying language structure. Languages of this kind have, for example, statements terminated by semicolons, code blocks separated by curly brackets, parameters separated by brackets, and/or arithmetic and logical expressions defined in infix notation. In some cases they are also referred to as “curly bracket languages”. In the present case, C code preferably also includes code in the programming language C++, Handel-C, and/or SA-C. More preferably, this means a standardized form of C code such as ANSI C, ANSI C++, ISO C, ISO C++, Standard C, and/or Standard C++, published by the American National Standards Institute (ANSI), ISO/IEC JTC 1/SC 22/WG 14, of the International Organization for Standardization (ISO), and ISO/IEC JTC 1/SC 22/WG 21 of The C++ Standards Committee (ISOCPP) of the International Organization for Standardization (ISO) and/or the International Electrotechnical Commission (IEC).

According to another preferred development of the invention, it is preferably provided that the target platform comprises a piece of heterogeneous hardware having a plurality of components, and that the control program is created such that control program portions which correspond to the blocks referencing the target specification object comprise instructions for execution that are tailored to the components. In the present case, a piece of heterogeneous hardware having a plurality of components preferably means hardware comprising a plurality of arithmetic logic units, preferably having different architectures, the arithmetic logic units preferably accessing a shared address space and memory. For example, the target platform can comprise a processor and an accelerator platform such as a GPU (graphics processing unit) or an FPGA. In particular, an advantage is that control programs that are tailored to different target platforms and take account of the specific characteristics of the heterogeneous hardware of the target platform can be created in a simple manner without having to lose the advantages of model-based development using the graphical control model.

The invention further relates to a method for configuring a target platform configured as a controller, the target platform comprising at least one arithmetic logic unit and preferably at least one sensor and/or actuator in order to acquire data on a physical process and/or to influence a physical process, comprising the steps of:
inputting a graphical control model of a development platform,
creating a control program for the target platform from the input graphical control model in accordance with the above-described method,
creating a code that is executable for the arithmetic logic unit of the target platform by compiling the created control program,
transmitting the created executable code to the target platform and/or storing the created executable code on a non-volatile memory of the target platform and/or executing the created executable code using the arithmetic logic unit of the target platform.

The controller preferably comprises an interface for connecting to the development platform. Further preferably, the controller comprises a microcontroller which has a different architecture from a processor of the development platform, as well as a working memory (RAM) and a non-volatile memory. Further preferably, the controller can have a piece of heterogeneous hardware having more than one arithmetic logic unit. Particularly preferably, the controller comprises a processor and an accelerator platform. Further preferably, the controller is configured such that the processor and the accelerator platform access a shared address space and working memory. Further preferably, the accelerator platform is selected from a GPU, a co-processor, in particular in the form of a co-processor (integrated in the main processor) of an APU (accelerated processing unit), a vector processor, a stream processor, a PPU (parallel processing unit), and/or an FPGA.

According to another preferred development of the invention, it is provided that the step of creating the control program for the target platform is carried out such that control program portions that correspond to the blocks referencing the target specification object comprise information for creating the executable code, and in the step of creating the code that is executable for the arithmetic logic unit of the target platform by compiling the created control program, the information for creating the executable code is taken into account. Particularly preferably, during the compiling, the information included through the link to the target specification object is used for creating the executable code such that an executable code tailored to the characteristics of the target platform is generated.

The invention further relates to a data processing device capable of carrying out the above-described computer-implemented method for creating the control program.

Particularly preferably, the device comprises a definition database for storing information relating to the graphical control model and in particular for storing the target specification object. The definition database can have a tree structure and/or be stored as a simple file in a memory of the device. Alternatively, it can be provided that the target specification object is stored in a dedicated database system.

The invention further relates to a computer program product comprising commands which, when the program is executed by a computer, cause said computer to carry out the above-described computer-implemented method for creating the control program.

The invention further relates to a computer-readable data medium on which the above computer program product is stored.

Preferably, the commands are embedded on the computer-readable data medium and, when the commands are executed by a processor of the computer, they cause the processor to carry out the method for creating the control program.

Technical advantages and effects of the method for configuring the target platform configured as the controller, of the data processing device, of the computer program product, and of the computer-readable data medium will become apparent to a person skilled in the art from the description of the method for creating the control program and from the embodiment examples described below.

The invention will be described in more detail below with reference to the drawings. The illustrated embodiments are highly schematic, i.e., the distances and the lateral and vertical dimensions are not true to scale and, unless indicated otherwise, do not have any derivable geometric relationships to each other either.

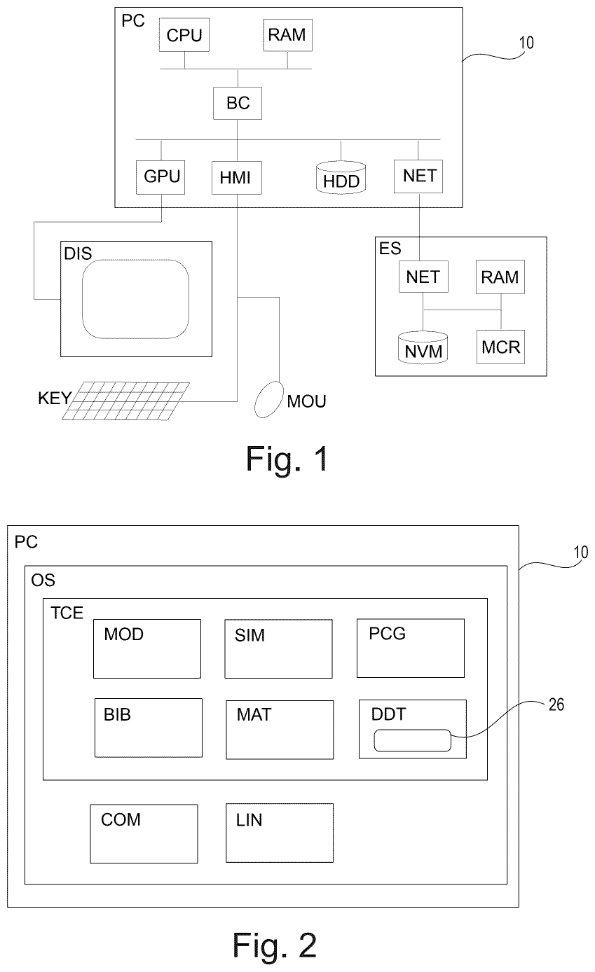

FIG. 1 schematically shows an example configuration of a data processing device 10, which is referred to as a computer system PC in the present case. The computer system PC is configured to carry out a method for creating a control program for a target platform ES from a graphical control model of a development platform, i.e., the computer system. The computer system PC has a processor CPU, which can be implemented in particular as a multi-core processor, as well as a working memory RAM and a bus controller BC. Preferably, the computer system PC is configured to be manually operated by a user, a monitor DIS being connected via a graphics card GPU and a keyboard KEY and a mouse MOU being connected via a human-machine interface HMI. In principle, the human-machine interface of the computer system PC could also be in the form of a touchscreen interface. The computer system PC further comprises a non-volatile data memory HDD, which in particular can be configured as a hard disk and/or a solid-state disk, as well as an interface NET, in particular a network interface. A controller ES, i.e., the target platform ES, can be connected via the interface NET. In principle, one or more interfaces of any kind, in particular wired interfaces, can be provided on the computer system PC and each used for connecting to a controller ES. Expediently, a network interface according to the Ethernet standard can be used; the interface NET can also be configured to be wireless, in particular as a WLAN interface or as per a standard such as Bluetooth.

The controller ES can be configured as a standard control unit or an evaluation board for the target platform ES. Expediently, it comprises an interface NET for connecting to the computer system PC, i.e., the development platform, a microcontroller MCR having a different architecture from the processor of the computer system PC, a working memory RAM, and a non-volatile memory NVM.

FIG. 2 shows a diagram of the software components preferably installed on the computer system PC. These use mechanisms of the operating system OS in order, for example, to access the non-volatile memory HDD or to establish a connection to an external computer and/or to the controller ES via the network interface NET.

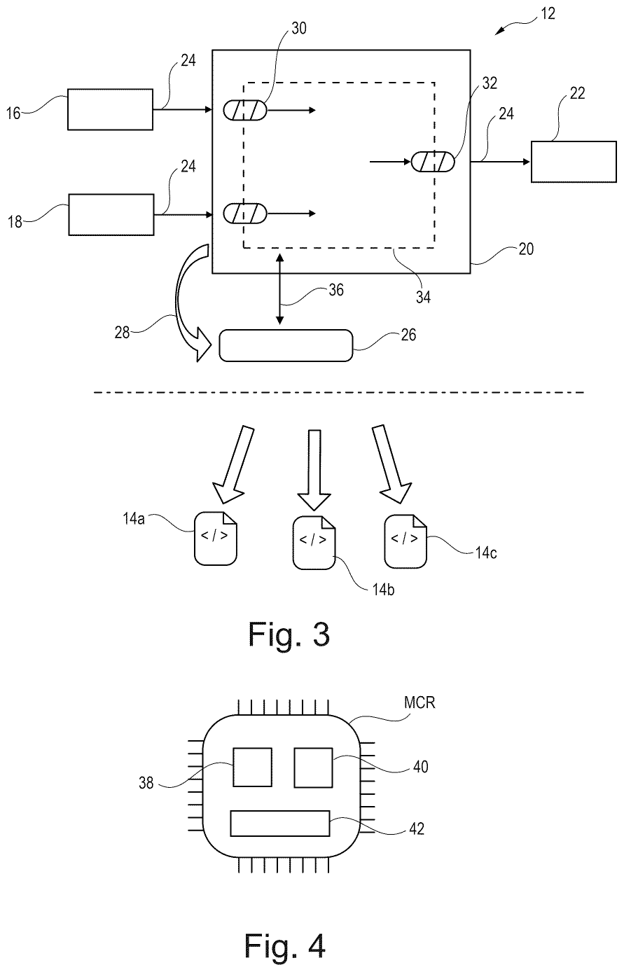

A technical computing environment TCE allows models, in particular graphical control models 12 (see FIG. 3) to be built and allows a control program 14 (also referred to as source code) to be created from the graphical control models 12. In a modeling environment MOD, graphical control models 12 of a dynamic system can preferably be built via a graphical user interface. This can in particular be block diagrams that comprise a plurality of blocks 16, 18, 20, 22 and describe the time response and/or the internal states of a dynamic system. At least some of the blocks 16, 18, 20, 22 can be interconnected via signal lines 24, the signal lines 24 constituting directional connections for exchanging signals. Operations and/or computing steps to be carried out on the signals can be defined via the blocks 16, 18, 20, 22. The graphical control model 12 references a definition database DDT in which information relating to the graphical control model 12 is stored.

The computing environment TCE comprises one or more libraries BIB from which blocks 16, 18, 20, 22 or modules for building a model 12 can be selected. In a script environment MAT, instructions can be input interactively or via a batch file, in order to perform calculations or modify the model 12. The computing environment TCE further comprises a simulation environment SIM configured to interpret or execute the block diagram in order to examine the time response of the system. These calculations are preferably carried out using highly accurate floating-point numbers on one or more cores of the microprocessor CPU of the computer system PC.

Via a code generator PCG, the control program 14 (also referred to as source code 14) which is preferably at least partly in a programming language such as C, can be created from a built model 12. In the present case, the source code 14 is entirely in text form and comprises instructions for the controller ES. To create the source code 14, the method for creating a control program for a target platform ES from the graphical control model 12 of the development platform is carried out in the present embodiment example. In the present embodiment example, it is provided that the definition database DDT comprises at least one target specification object 26, the target specification object 26 comprising target platform-specific generation rules for the control program 14. As shown in FIG. 3, one of the blocks 16, 18, 20, 22, namely the block 20 of the graphical control model 12, references the target specification object 26, as illustrated by the arrow 28. As illustrated by the bottom half of FIG. 3, the target platform-specific generation rules for control program portions that correspond to the blocks 20 referencing 28 the target specification object 26 are taken into account when the control program 14 is created. In this way, target platform-specific implementation variants of the control program 14a, 14b, 14c which take account of the specific features of the specific target platform can be created. In particular, target platform-specific characteristics and dependencies can thus be taken into account in the build process of the control program 14, i.e., in the operation in which code that is executable for the arithmetic logic unit MCR of the target platform ES is created in an automated manner and the executable code is compiled and/or linked to program libraries. Accordingly, in the present case the target specification object 26 comprising the target platform-specific generation rules is retained in the definition database DDT.

Furthermore, other additional information relating to the model 12 can also be stored in the definition database DDT, such as information relating to the variables in the blocks (referred to as block variables). Value ranges and/or scales can be assigned to the block variables in order to assist with the calculation of the model 12 using fixed-point instructions. Moreover, desired properties of the source code, for example compliance with a standard such as MISRA, can be set or stored in the definition database DDT. Each block variable can be assigned to a predetermined variable type, and/or one or more desired properties can be set, for example the admissibility of optimizations such as combining variables.

The code generator PCG preferably analyzes the settings of the definition database DDT, in particular the stored target specification object 26, and uses this information when creating the source code 14. The definition database DDT can have a tree structure or be stored as a simple file in a memory of the computer system PC; alternatively, it can be provided that the definition data are stored in a dedicated database system. The definition database DDT can have a programming interface and/or import/export functions.

In this embodiment example, the computer system PC additionally has a compiler COM and a linker LIN, which expediently are configured for creating code that is executable on the controller ES. In principle, there may be a multiplicity of compilers, in particular cross-compilers for different target platforms, in order to support controllers or evaluation boards ES having different processor architectures.

On the basis of an example graphical control model 12, FIG. 3 shows the principle of the computer-implemented method for generating the control program 14 for the target platform ES. As shown by FIG. 3, the block 20 referencing the target specification object 26 (indicated by arrow 28) has two signal lines 24 for receiving output signals of the blocks 16 and 18. Each signal input at the block 20 is implemented by way of an input port 30. The block 20 processes the signals and generates a result that is transmitted to the block 22 via the output port 32 and the signal lines 24. The signal processing within the block 20 is not specifically shown in FIG. 3. Generally, it can include a multiplicity of blocks in a subordinate layer which describe the structure of the block 20.

Since the block 20 of the graphical control model 12 references the target specification object 26, target platform-specific generation rules for control program portions corresponding to the functionality 34 of the block 20 are taken into account when the control program 14 is created, as illustrated highly schematically in the bottom half of FIG. 3. FIG. 3 schematically shows the functionality 34 of the block 20 by a dashed line 34; the double-headed arrow 36 illustrates the taking into account of target platform-specific generation rules, stored in the target specification object 26, for control program portions that correspond to the functionality 34 of the block 20. In particular, the control program 14 is generated in such a way that a function prototype, corresponding to the transmission of the result of the function, of the control program 14 implementing the functionality 34 of the block 20 is independent of the target platform-specific configuration of the control program 14. This is illustrated in FIG. 3 in that the signal input and signal output interfaces, by way of the input ports 30 and the output port 32, are each half inside the area enclosed by the dashed line 34. Thus, despite the target platform-specific configuration of the function, the interface of the function is the same for all possible target platform-specific configurations in the generated control program 14.

FIG. 4 schematically shows an embodiment example of the hardware MCR of the target platform ES. In the present case, the hardware MCR is configured as heterogeneous hardware having a plurality of components 38, 40. The component 38 is the main processor 38, and the component 40 is an accelerator platform 40. The main processor 38 and the accelerator platform 40 access a shared address space and a shared working memory 42.

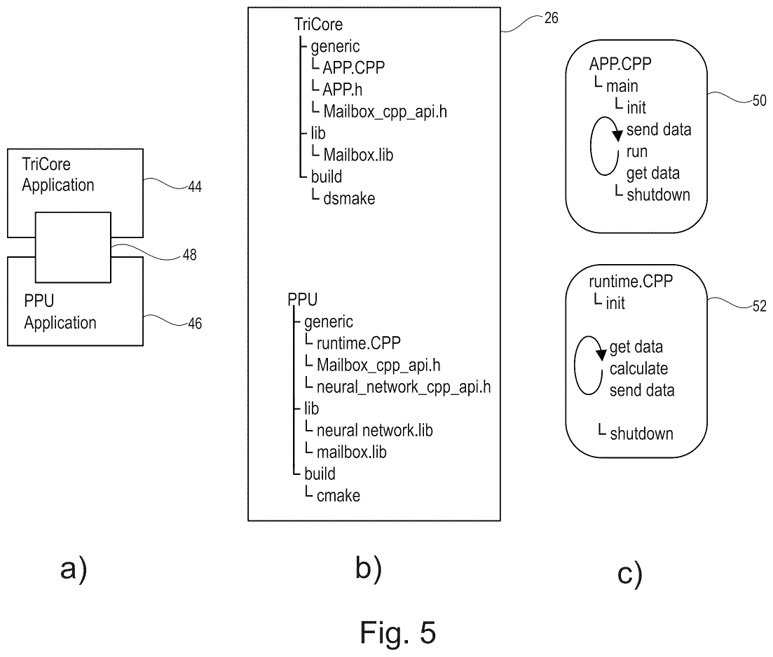

Hereinafter, with reference to FIG. 5, an implementation example will first be described in which the main processor 38 is configured as a TriCore™ processor 38 and the accelerator platform 40 is configured as a PPU 40. The software architecture for these components 38, 40 is shown in FIG. 5a). The TriCore™ processor 38 executes the TriCore™ application 44, while the PPU 40 executes the PPU application 46. The TriCore™ application 44 and the PPU application 46 communicate via an interface 48. In the present case, this is configured as a mailbox system; the TriCore™ application 44 can reserve and request services of the PPU application 46 in order to outsource specific calculations such as vector commands to the PPU 40. In the present case, the PPU 40 is used to perform calculations using an artificial neural network.

FIG. 5b) schematically shows an illustration of a target specification object 26 for the architecture shown in FIG. 5a). The target specification object 26 has the target platform-specific generation rules for the control program 14.

In the present case, for the TriCore™ application 44, the identifier of the TriCore™ application “APP.CPP” and the identifier for the header file thereof “APP.h” are stored in the target specification object 26 under “generic”. The header file supplies in particular information on the available function prototypes. The identifier “Mailbox_cpp_api.h” for the mailbox system of the interface 48 is also stored under “generic”. The identifier for the program library relating to the mailbox system, “Mailbox.lib”, is stored under “lib”. Furthermore, the identifier “dsmake” is stored in the target specification object 26 under “build”. Accordingly, the process dsmake, which analyzes a makefile containing the call-up of the compiler COM and linker LIN, is called up during the build process. The makefile is built and/or adapted while taking account of the target platform-specific generation rules stored in the target specification object 26.

For the PPU application 46, the identifier of the PPU application “runtime. CPP”, the identifier “Mailbox_cpp_api.h” for the mailbox system of the interface 48, and the identifier “neural_network_cpp_api.h” for the process performing the calculations using the artificial neural network are stored in the target specification object 26 under “generic”. Accordingly, the identifier for the program library relating to the mailbox system, “Mailbox.lib”, and the identifier for the program library relating to the artificial neural network, “neural network.lib”, are specified under “lib”. Furthermore, the identifier “cmake” for the process that analyzes the makefile and performs the call-up of the compiler COM and the linker LIN is specified in the target specification object 26 under “build”. The makefile is built and/or adapted while taking account of the target platform-specific generation rules stored in the target specification object 26.

FIG. 5c) shows a schematic program sequence of the generated control program 14 on the hardware and software architecture, shown in FIGS. 4 and 5a), of the target platform ES for the components 38 and 40. The program sequence on the TriCore™ processor 38 is shown in 50 and contains the initialization of the process of the control program 14, shortened to “init”, the provision of data to the PPU, shortened to “send data”, the sequence, shortened to “run”, the retrieval of results from the PPU, shortened to “get data”, said results generally being processed further still, and the termination of the process, “shutdown”.

During the program sequence 50, therefore, a calculation is outsourced to the PPU such that the PPU application 46 runs through the sequence 52, namely the initialization of the process, shortened to “init”, a request for data, “get data”, a calculation, “calculate”, and sending of data via the interface 48, “send data”, before the process is ended, “shutdown”.

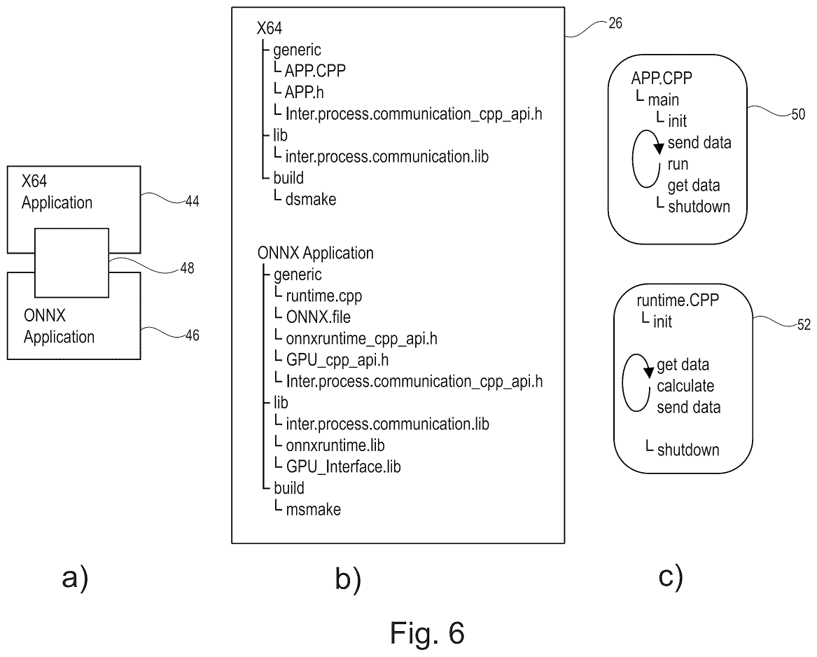

Similarly to FIG. 5, FIG. 6 shows a further embodiment example of the invention. Whereas in FIG. 5 the main processor 38 is configured as a TriCore™ processor and the accelerator platform 40 as a PPU, in FIG. 6 the main processor 38 is configured as an X86_64 processor 38 and the accelerator platform 40 as a graphics processor, GPU 40.

In the present case, the GPU 40 is used to perform calculations using an artificial neural network. Accordingly, as shown in FIG. 6a), an X64 application 44 is executed by the X86_64 processor 38 while an ONNX application 46 is executed by the GPU 40. The X64 application 44 and the ONNX application 46 communicate via an interface 48. In the present case, this is configured as IPC (interprocess communication) via a C interface.

FIG. 6b) schematically shows an illustration of a target specification object 26 for the architecture shown in FIG. 6a). The target specification object 26 has the target platform-specific generation rules for the control program 14.

In the present case, for the X64 application 44, the identifier of the X64 application “APP.CPP” and the identifier for the header file thereof “APP.h” are stored in the target specification object 26 under “generic”. The identifier “Inter.process.communication_cpp_api.h” for the interprocess communication of the interface 48 is also stored under “generic”. The identifier for the program library relating to the interprocess communication, “inter.process.communication.lib”, is stored under “lib”. Furthermore, the identifier “dsmake” is stored in the target specification object 26 under “build”. The identifier “dsmake” specifies the process that analyzes the makefile during the build process, the makefile being built and/or adapted while taking account of the target platform-specific generation rules stored in the target specification object 26.

For the ONNX application 46, the identifier of the ONNX application, “runtime.cpp”, the identifier of the header file, “onnxruntime_cpp_api.h”, and the identifier for the necessary ONNX files, “ONNX.file”, are stored in the target specification object 26 under “generic”. Furthermore, the identifier “GPU_cpp_api.h” for outsourcing calculations to the GPU 40 and the identifier “Inter.process.communication_cpp_api.h” for the interprocess communication of the interface 48 are also stored under “generic”. The identifier for the program library relating to the interprocess communication, “inter.process.communication.lib”, the identifier for the program library relating to the ONNX application, “onnxruntime.lib”, and the identifier for the program library relating to the outsourcing to the GPU, “GPU_Interface.lib”, are stored under “lib”. Furthermore, the identifier “msmake” is stored in the target specification object 26 under “build”. The identifier “msmake” specifies the process that analyzes the makefile during the build process, the makefile being built and/or adapted while taking account of the target platform-specific generation rules stored in the target specification object 26.

FIG. 6c) schematically shows a schematic program sequence of the generated control program 14 on the hardware and software architecture, shown in FIGS. 4 and 6a), of the target platform ES for the components 38 and 40. The program sequence on the X86_64 processor 38 is shown in 50 and contains the initialization of the process of the control program 14, shortened to “init”, the provision of data to the GPU, shortened to “send data”, the sequence, shortened to “run”, the retrieval of results from the GPU, shortened to “get data”, said results generally being processed further still, and the termination of the process, “shutdown”.

During the program sequence 50, therefore, a calculation is outsourced to the GPU 40 via interprocess communication such that the ONNX application 46 runs through the sequence 52, namely the initialization of the process, shortened to “init”, a request for data, “get data”, a calculation, “calculate”, and sending of data via the interface 48, “send data”, before the process is ended, “shutdown”.

The embodiment examples described are merely examples that can be modified and/or added to in many different ways within the scope of the claims. Any feature described for a particular embodiment example can be used independently or in combination with other features in any other embodiment example. Any feature described for an embodiment example of a particular category can also be used accordingly in an embodiment example of a different category.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Data processing device
12 Graphical control model
14 Control program
16 Block
18 Block
20 Block that references the target specification object
22 Block
24 Signal line
26 Target specification object
28 Arrow indicating the referencing
30 Input port
32 Output port
34 Functionality of the block 20
36 Double-headed arrow
38 Main processor, TriCore™, X86_64
40 Acceleration platform, PPU, GPU
42 Memory
44 Application of the main processor
46 Application of the accelerator platform
48 Interface, mailbox system, C interface for IPC
50 Program sequence of the main processor application
52 Program sequence of the accelerator platform application
PC Computer system
CPU Processor
RAM Working memory
BC Bus controller
GPU Graphics card
DIS Monitor
HMI Peripheral interface
KEY Keyboard
MOU Mouse
HDD Non-volatile data memory
NET Interface, network interface
ES Controller
MCR Microcontroller
NVM Memory
OS Operating system
TCE Technical computing environment
MOD Modeling environment
BIB Library
MAT Script environment
SIM Simulation environment
PCT Code generator
DDT Definition database
COM Compiler
LIN Linker

1. A computer-implemented method for generating a control program for a target platform from a graphical control model of a development platform,
the graphical control model comprising a block diagram having a plurality of blocks,
the graphical control model referencing a definition database in which information relating to the graphical control model is stored,
the definition database comprising at least one target specification object,
wherein the method comprises:
generating the control program according to target platform-specific generation rules for the control program comprised in the target specification object, wherein the target specification object is referenced by one or more blocks of the graphical control model, and wherein the target platform-specific generation rules for control program portions that correspond to the blocks referencing the target specification object are taken into account when generating the control program.

2. The method according to claim 1, wherein the target platform-specific generation rules for the control program take into account characteristics of a control program language, a piece of hardware of the target platform, a hardware setting of the target platform, a runtime environment of the target platform, a compiler for creating from the control program, a code which is executable for an arithmetic logic unit of the target platform, a compiler version, and/or a compiler setting.

3. The method according to claim 1, wherein a respective block of the graphical control model which references the target specification object performs signal processing,
wherein the result of the signal processing is used by at least one other block in the graphical control model, and
wherein the control program is generated in such a way that a function prototype corresponding to the transmission of the result is independent of the target platform-specific configuration of a respective portion of the control program which corresponds to the respective block referencing the target specification object.

4. The method according to claim 3, wherein the respective block of the graphical control model which references the target specification object relays a signal to the at least one other block, and
wherein the control program is generated in such a way that information about a return value of a function in the function prototype is independent of the target platform-specific configuration of the respective portion of the control program which corresponds to the respective block referencing the target specification object.

5. The method according to claim 4, wherein the respective block of the graphical control model which references the target specification object receives at least one signal, and
wherein the control program is generated in such a way that information about function parameters in the function prototype is independent of the target platform-specific configuration of the respective portion of the control program which corresponds to the respective block referencing the target specification object.

6. The method according to claim 1, wherein the block diagram has a hierarchical structure and comprises at least one first subsystem and one second subsystem,
wherein the first subsystem is an external subsystem,
wherein the second subsystem is comprised by the first subsystem,
wherein the second subsystem comprises at least one block which references the target specification object, and
wherein the control program is generated in such a way that the referencing is hierarchically transmitted from a respective portion of the control program corresponding to the second subsystem to a respective portion of the control program corresponding to the first subsystem.

7. The method according to claim 1, wherein generating the control program comprises including the target specification object for a respective portion of the control program which corresponds to a respective block referencing the target specification object as a link.

8. The method according to claim 1, wherein a respective block of the graphical control model which references the target specification object is configured as a function block having an external function.

9. The method according to claim 1, wherein generating the control program comprises:
creating an intermediate representation from the graphical control model,
optimizing the created intermediate representation, and
creating the control program for the target platform by translating the optimized intermediate representation.

10. The method according to claim 1, wherein the control program is generated such that respective control program portions which correspond to respective blocks referencing the target specification object comprise information for generating executable code.

11. The method according to claim 1, wherein the target platform comprises a piece of heterogeneous hardware having a plurality of components, and
wherein the control program is generated such that respective control program portions which correspond to respective blocks referencing the target specification object comprise instructions for execution that are tailored to the components.

12. The method according to claim 1, further comprising: prior to generating the control program, inputting the graphical control model of the development platform,
after generating the control program, generating a code that is executable for an arithmetic logic unit of the target platform by compiling the control program, and
transmitting the executable code to the target platform, storing the executable code on a non-volatile memory of the target platform, and/or executing the executable code using the arithmetic logic unit of the target platform.

13. The method according to claim 12, wherein the target platform comprises at least one sensor configured to acquire data on a physical process and/or at least one actuator configured to influence a physical process.

14. The method according to claim 12, wherein generating the code that is executable for the arithmetic logic unit of the target platform takes into account information for creating the executable code.

15. A data processing device, comprising:
at least one memory having processor-executable instructions stored thereon for generating a control program for a target platform from a graphical control model of a development platform, the graphical control model comprising a block diagram having a plurality of blocks, the graphical control model referencing a definition database in which information relating to the graphical control model is stored, and the definition database comprising at least one target specification object; and
at least one processor configured to execute the processor-executable instructions to facilitate performance of the following by data processing device: generating the control program according to target platform-specific generation rules for the control program comprised in the target specification object, wherein the target specification object is referenced by one or more blocks of the graphical control model, and wherein the target platform-specific generation rules for control program portions that correspond to the blocks referencing the target specification object are taken into account when generating the control program.

16. A non-transitory computer-readable medium having processor-executable instructions stored thereon for generating a control program for a target platform from a graphical control model of a development platform, the graphical control model comprising a block diagram having a plurality of blocks, the graphical control model referencing a definition database in which information relating to the graphical control model is stored, and the definition database comprising at least one target specification object, wherein the processor-executable instructions, when executed, facilitate performance of the following:
generating the control program according to target platform-specific generation rules for the control program comprised in the target specification object, wherein the target specification object is referenced by one or more blocks of the graphical control model, and wherein the target platform-specific generation rules for control program portions that correspond to the blocks referencing the target specification object are taken into account when generating the control program.
